(19) United States
(12) Patent Application Publication
(10) Pub. No.: US 2026/0008172 A1
(43) Pub. Date: Jan. 8, 2026

(54) MODULAR MAGNETIC TOOL RACK

(71) Applicant: HSIANG-YUN CHEN, TAICHUNG (TW)

(72) Inventor: HSIANG-YUN CHEN, TAICHUNG (TW)

(21) Appl. No.: 19/174,163

(22) Filed: Apr. 9, 2025

(30) Foreign Application Priority Data
Jul. 3, 2024 (TW) 113124877

(51) Int. Cl. B25H 3/04; B25H 3/00

(52) U.S. Cl. CPC B25H 3/04; B25H 3/003

(57) ABSTRACT

A modular magnetic tool rack comprising a main body with a sliding groove featuring a wide section and a narrow section, and a connector assembly. The assembly includes a sliding seat movably disposed within the groove, a connector body with a screw-lock connection, and a magnetic piece housed in an accommodating slot. The connector body can be tightened to lock the sliding seat or loosened to allow longitudinal movement along the main body.

### BACKGROUND OF THE INVENTION

The present invention relates to a tool rack, and more particularly to a modular magnetic tool rack.

Taiwan Patent No. M424221 comprises a socket holder and a cover member with a magnetic member disposed therebetween. The cover member is joined to the inner edge of the socket holder and is suitable for tool sockets without outer connecting flanges. The magnetic member provides magnetic force for attracting metal objects, while the flat structure of the cover member provides a surface for attachment.

However, in such tool socket organizers, the socket placement slots use protruding flanges on the slot walls to secure the sockets. While this prevents sockets from falling out, it also creates resistance when inserting sockets into the slots. Significant force is required to press the sockets into place. Additionally, the protruding flanges on the slot walls are prone to wear during use, which reduces their securing effectiveness over time.

The present invention is, therefore, intended to obviate or at least alleviate the problems encountered in the prior art.

### SUMMARY OF THE INVENTION

The present invention provides a modular magnetic tool rack comprising a main body and a connector assembly. The main body has a sliding groove extending along its longitudinal direction. The sliding groove includes a wide section and a narrow section. Along its short edge direction, the main body has a first side and an opposite second side. The wide section has a first width extending between the first side and the second side. The narrow section connects the wide section to an outer periphery of the main body and has a second width extending between the first side and the second side. The second width is less than the first width.

The connector assembly comprises a first sliding seat, a first connector body, and a first magnetic piece. The first sliding seat is movably disposed within the wide section and can move along the longitudinal direction of the main body. The first sliding seat includes a first slot configured to receive a first end of the first connector body in a screw-lock manner and a first accommodating slot proximate to the first slot configured to house the first magnetic piece. A second end of the first connector body protrudes through the narrow section to extend outside the main body.

When the first connector body is tightened to the first sliding seat, the first connector body abuts against the outer periphery of the main body, preventing the first sliding seat from moving relative to the main body. Conversely, when the first connector body is loosened from the first sliding seat, the first connector body separates from the outer periphery of the main body, allowing the first sliding seat to move relative to the main body.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a first embodiment of the modular magnetic tool rack of the present invention.

FIG. 2 is an exploded perspective view of the first embodiment.

FIG. 3 is a cross-sectional view of the first embodiment.

FIG. 4 is another cross-sectional view of the first embodiment from a different angle.

FIG. 5 is an exploded perspective view of a second embodiment of the modular magnetic tool rack.

FIG. 6 is a cross-sectional view of the second embodiment.

FIG. 7 is another cross-sectional view of the second embodiment from a different angle.

### DETAILED DESCRIPTION OF THE INVENTION

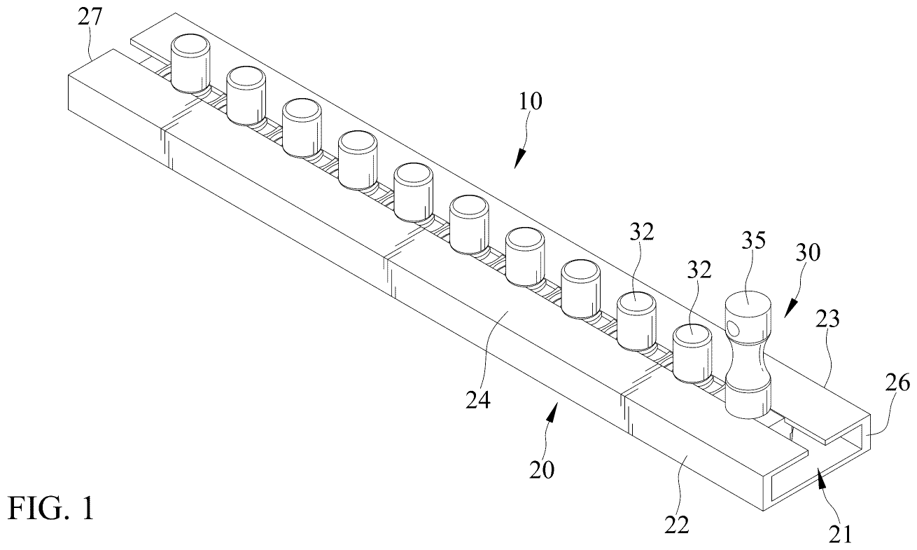

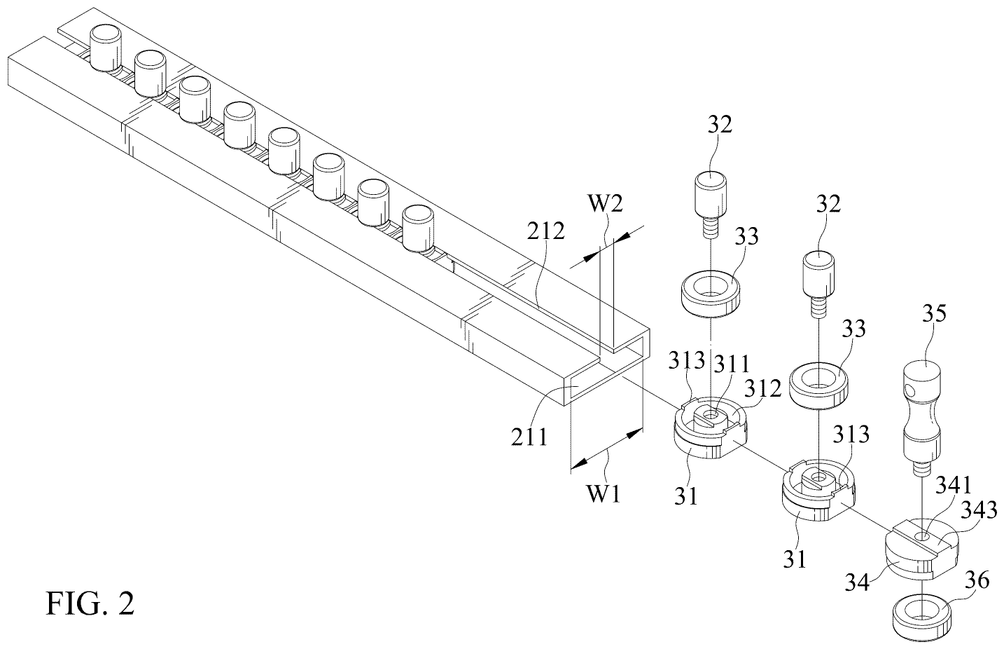

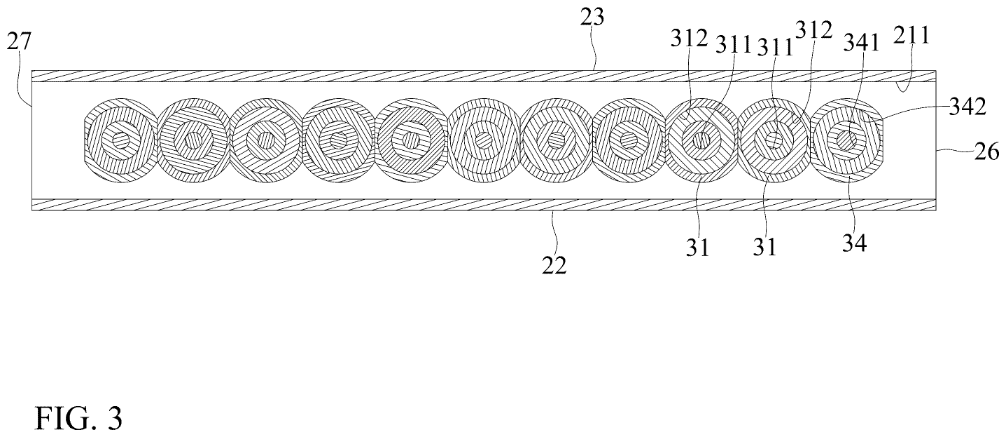

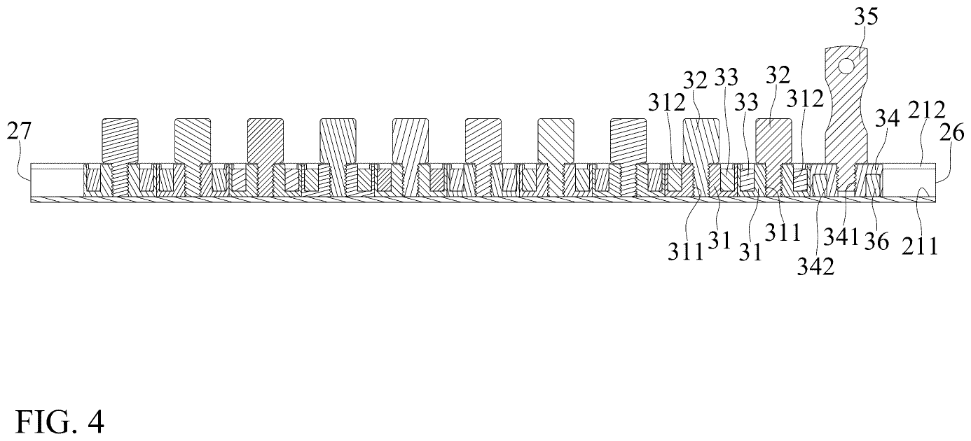

Referring to FIGS. 1-4, a modular magnetic tool rack 10 in accordance with the present invention comprises a main body 20 and a connector assembly 30.

The main body 20 includes a sliding groove 21 extending along its longitudinal direction. The sliding groove 21 has a wide section 211 and a narrow section 212. Along its short edge direction, the main body 20 includes a first side 22 and an opposite second side 23. The wide section 211 has a first width W1 measured between the first side 22 and the second side 23. The narrow section 212 connects the wide section 211 to the outer periphery of the main body 20. The narrow section 212 has a second width W2 measured between the first side 22 and the second side 23. The second width W2 is less than the first width W1.

The connector assembly 30 includes a first sliding seat 31, a first connector body 32, and a first magnetic piece 33. The first sliding seat 31 is movably disposed within the wide section 211 and can move along the longitudinal direction of the main body 20. The first sliding seat 31 includes a first slot 311 and a first accommodating slot 312 proximate to the first slot 311. The first slot 311 is configured to receive a first end of the first connector body 32 in a screw-lock manner, utilizing complementary threading on the first slot 311 and the first end of the first connector body 32. The “screw-lock manner” refers to a connection mechanism where mating threads on the first slot 311 and connector body allow secure engagement through rotational tightening, with the threads providing both positioning and holding force when fully engaged. A second end of the first connector body 32 protrudes through the narrow section 212 to extend outside the main body 20. The first accommodating slot 312 is configured to house the first magnetic piece 33.

When the first connector body 32 is tightened to the first sliding seat 31, the first connector body 32 firmly abuts against the outer periphery of the main body 20, creating a friction force that prevents the first sliding seat 31 from moving relative to the main body 20 along the longitudinal direction. When the first connector body 32 is loosened from the first sliding seat 31, it separates from the outer periphery of the main body 20, eliminating the friction force and allowing the first sliding seat 31 to freely move relative to the main body 20 along the longitudinal direction.

The outer periphery of the main body 20 includes a front face 24. The narrow section 212 connects the wide section 211 to the front face 24. The first sliding seat 31 includes a first protrusion 313 on its side proximate to the front face 24. The first protrusion 313 extends into the narrow section 212. The first protrusion 313 is sized and shaped to engage with the narrow section 212 in a manner that prevents rotational movement of the first sliding seat 31 relative to the main body 20 while still allowing longitudinal movement when the first connector body 32 is loosened.

The connector assembly 30 further includes a second sliding seat 34, a second connector body 35, and a second magnetic piece 36. The second sliding seat 34 is movably disposed within the wide section 211 and can move along the longitudinal direction of the main body 20. The second sliding seat 34 includes a second slot 341 and a second accommodating slot 342 proximate to the second slot 341. One end of the second connector body 35 is inserted into the second slot 341 using a screw-lock mechanism, while its other end protrudes through the narrow section 212 to extend outside the main body 20. The second magnetic piece 36 is housed within the second accommodating slot 342.

When the second connector body 35 is tightened to the second sliding seat 34, the second connector body 35 abuts against the front face 24, preventing the second sliding seat 34 from moving relative to the main body 20. When loosened, the second connector body 35 separates from the front face 24, allowing the second sliding seat 34 to move relative to the main body 20. The second sliding seat 34 includes a second protrusion 343 on its side proximate to the front face 24. This second protrusion 343 extends into the narrow section 212 and prevents the second sliding seat 34 from rotating relative to the main body 20.

The outer periphery of the main body 20 includes a back face 25 opposite to the front face 24. The first accommodating slot 312 extends from the side of the first sliding seat 31 proximate to the front face 24 toward the side proximate to the back face 25. The second accommodating slot 342 extends from the side of the second sliding seat 34 proximate to the back face 25 toward the side proximate to the front face 24.

The first accommodating slot 312 is annular and surrounds the first slot 311, and the first magnetic piece 33 is correspondingly annular in shape. Similarly, the second accommodating slot 342 is annular and surrounds the second slot 341, and the second magnetic piece 36 is also annular in shape.

The main body 20 includes a first end 26 and an opposite second end 27 along its longitudinal direction. The sliding groove 21 connects between the first end 26 and the second end 27.

In the present embodiment, there are multiple first sliding seats 31, first connector bodies 32, and first magnetic pieces 33, with the quantities being equal. The multiple first connector bodies 32 and first magnetic pieces 33 are respectively connected to the multiple first sliding seats 31. The second sliding seat 34 is positioned proximate to the first end 26, and the multiple first sliding seats 31 are disposed between the second sliding seat 34 and the second end 27.

Through this structure, the tool rack 10 can securely hold sockets. When securing a socket to the tool rack 10, the socket can be mounted onto either the first connector body 32 or the second connector body 35. The first magnetic piece 33 and second magnetic piece 36 are positioned to align with the metallic portions of the socket, providing optimal magnetic attraction. Additionally, the first connector body 32 and second connector body 35 serve as positioning elements, preventing the socket from easily detaching from the tool rack 10.

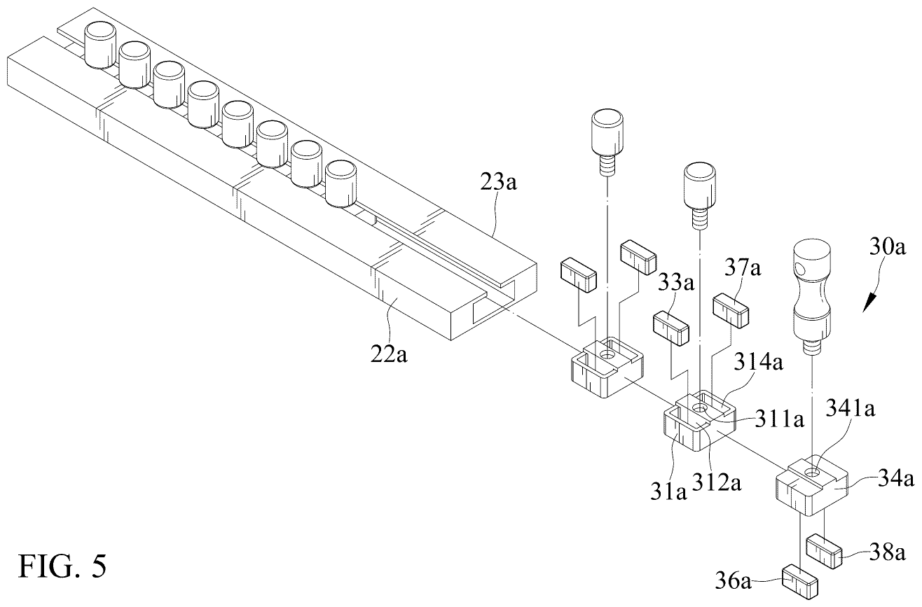

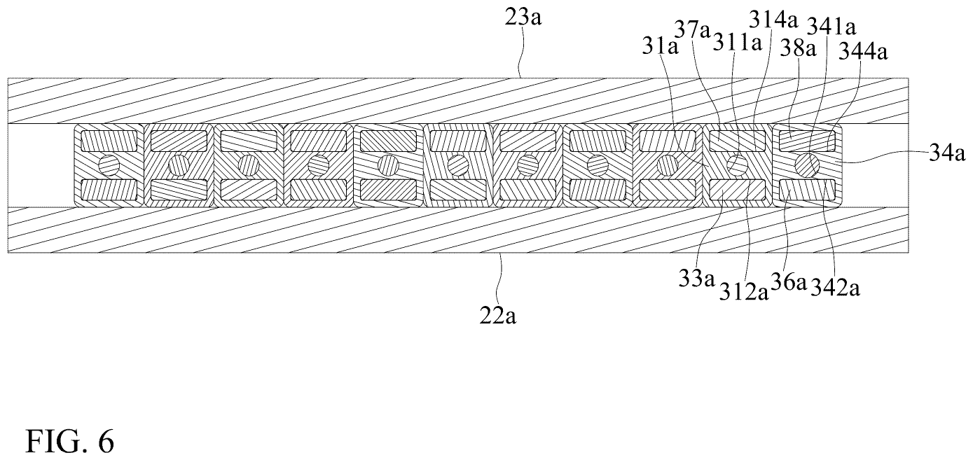

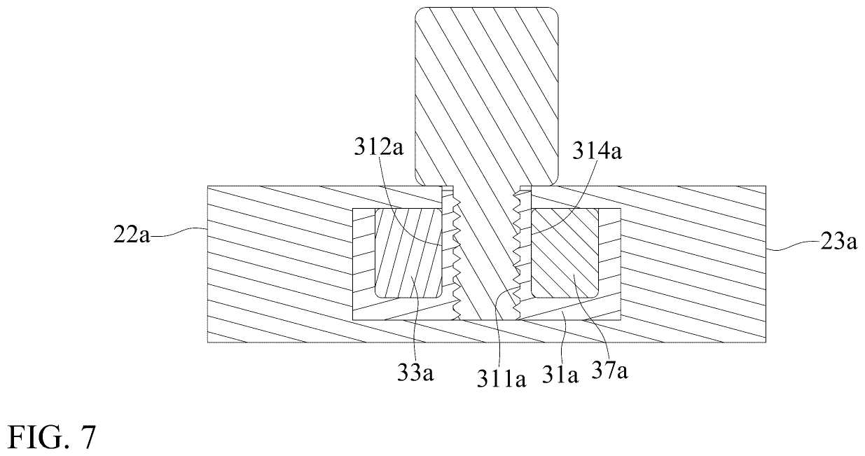

Referring now to FIGS. 5-7, a modular magnetic tool rack according to a second embodiment shares many characteristics with the first embodiment but introduces structural modifications to enhance cutting insert retention and assembly flexibility. Components similar to those of the first embodiment have like reference numerals with the suffix “a”.

The second embodiment is largely similar to the first embodiment, with the main difference being that a connector assembly 30a includes a third magnetic piece 37a and a fourth magnetic piece 38a. A first accommodating slot 312a is disposed on the side of a first slot 311a proximate to a first side 22a. A first sliding seat 31a includes a third accommodating slot 314a proximate to the first slot 311a and disposed on the side of the first slot 311a proximate to a second side 23a. The third magnetic piece 37a is housed within the third accommodating slot 314a.

A second accommodating slot 342a is disposed on the side of a second slot 341a proximate to the first side 22a. A second sliding seat 34a includes a fourth accommodating slot 344a proximate to the second slot 341a and disposed on the side of the second slot 341a proximate to the second side 23a. The fourth magnetic piece 38a is housed within the fourth accommodating slot 344a.

In the present embodiment, there are multiple first sliding seats 31a and first connector bodies, with the quantities being equal.

The first accommodating slot 312a and second accommodating slot 342a have rectangular cross-sections along the radial direction of the first slot 311a. The third accommodating slot 314a and fourth accommodating slot 344a have rectangular cross-sections along the radial direction of the second slot 341a. Each of a first magnetic piece 33a, second magnetic piece 36a are rectangular in shape. Similarly, the third magnetic piece 37a, and fourth magnetic piece 38a are rectangular in shape.

In the second embodiment, the first accommodating slot 312a and second accommodating slot 342a are formed with precise rectangular cross-sections when viewed along the radial direction of their respective slots 311a and 341a. Similarly, the third accommodating slot 314a and fourth accommodating slot 344a are formed with rectangular cross-sections when viewed along the radial direction of their respective slots. The first magnetic piece 33a, second magnetic piece 36a, third magnetic piece 37a, and fourth magnetic piece 38a are each formed in a rectangular shape with parallel faces and right angles, allowing for precise fitting within their respective accommodating slots while maintaining optimal magnetic field orientation.

In view of the foregoing, the modular magnetic tool rack 10 enables secure attachment of sockets while allowing for easy adjustment and customization of the tool rack configuration.

Although specific embodiments have been illustrated and described, numerous modifications and variations are still possible without departing from the scope of the invention. The scope of the invention is limited by the accompanying claims.

1. A modular magnetic tool rack comprising:
a main body, wherein the main body has a sliding groove extending along its longitudinal direction, and wherein the sliding groove comprises a wide section having a first width between a first side and a second side of the main body; a narrow section connecting the wide section to an outer periphery of the main body and having a second width between the first side and the second side being less than the first width; and
a connector assembly comprising at least one first sliding seat movably disposed within the wide section and configured to move along the longitudinal direction of the main body; at least one first connector body having a first end configured to be inserted into a first slot of the first sliding seat in a screw-lock manner, and a second end protruding through the narrow section outside the main body; one or more magnetic piece housed in a first accommodating slot adjacent to the first slot of the first sliding seat;
wherein when the first connector body is tightened to the first sliding seat, the first connector body abuts against the outer periphery of the main body to prevent movement of the first sliding seat relative to the main body, and when the first connector body is loosened from the first sliding seat, the first connector body separates from the outer periphery, allowing the first sliding seat to move relative to the main body.

2. The modular magnetic tool rack of claim 1, wherein the main body's outer periphery includes a front face, and the narrow section connects the wide section to the front face.

3. The modular magnetic tool rack of claim 2, further comprising: a second sliding seat movably disposed within the wide section; a second connector body having a first end inserted into a second slot of the second sliding seat in a screw-lock manner, a second end of the second connector body protruding through the narrow section outside the main body; and a second magnetic piece housed in a second accommodating slot adjacent to the second slot of the second sliding seat, wherein when the second connector body is tightened to the second sliding seat, the second connector body abuts against the front face to prevent movement of the second sliding seat relative to the main body, and when the second connector body is loosened from the second sliding seat, the second connector body separates from the front face, allowing the second sliding seat to move relative to the main body.

4. The modular magnetic tool rack of claim 3, wherein the first accommodating slot extends from a side of the first sliding seat proximate to the front face toward a side proximate to a back face of the main body, and wherein the second accommodating slot extends from a side of the second sliding seat proximate to the back face toward a side proximate to the front face.

5. The modular magnetic tool rack of claim 4, wherein: the first accommodating slot is annular and surrounds the first slot, wherein the first magnetic piece is annular, wherein the second accommodating slot is annular and surrounds the second slot, and wherein the second magnetic piece is annular.

6. The modular magnetic tool rack of claim 3, wherein the connector assembly further includes a third magnetic piece; a fourth magnetic piece; a third accommodating slot provided on a side of the first slot proximate to the second side; and a fourth accommodating slot provided on a side of the second slot proximate to the second side, wherein the third magnetic piece is housed in the third accommodating slot, and wherein the fourth magnetic piece is housed in the fourth accommodating slot.

7. The modular magnetic tool rack of claim 6, wherein: the first and second accommodating slots have rectangular cross-sections along the radial direction of their respective slots, wherein the third and fourth accommodating slots have rectangular cross-sections along the radial direction of their respective slots, and wherein the first, second, third, and fourth magnetic pieces are rectangular in shape.

8. The modular magnetic tool rack of claim 1, wherein the first sliding seat includes a protrusion preventing rotational movement.
